(19) United States
(12) Patent Application Publication
(10) Pub. No.: US 2015/0074470 A1
(43) Pub. Date: Mar. 12, 2015

(54) NON-VOLATILE MEMORY ASSEMBLIES

(71) Applicants: James Timothy Stott, Staffordshire (GB); Robin Philip Couch, Devon (GB)

(72) Inventors: James Timothy Stott, Staffordshire (GB); Robin Philip Couch, Devon (GB)

(73) Assignee: ALSTOM TECHNOLOGY LTD, BADEN (CH)

(21) Appl. No.: 14/385,478

(22) PCT Filed: Mar. 27, 2012
(86) PCT No.: PCT/EP2012/055428

§ 371 Date: Sep. 15, 2014

(51) Int. Cl. G06F 11/07; G06F 11/16

(52) U.S. Cl. CPC G06F 11/0787; G06F 11/1612
USPC 714/54

(57) ABSTRACT

A non-volatile memory assembly, for use in a programmable device within a power transmission network, comprises a non-volatile reprogrammable primary memory portion and a secondary memory portion. The non-volatile memory assembly also includes a controller that is configured to direct a programmable device to access data from the secondary memory portion; refresh the data in the primary memory portion with data from the secondary memory portion; and direct the programmable device to access data from the primary memory portion.

### BACKGROUND OF THE INVENTION

1. Field of the Invention

This invention relates to a non-volatile memory assembly for use in a programmable device within a power transmission network, and to a method of extending the operational lifetime of such a programmable device.

2. Description of the Related Art

Many items of equipment in a power transmission network, such as for example high voltage power converters, include one or more electronic programmable devices.

Such devices are typically operated using data stored in reprogrammable non-volatile memory, i.e. memory that can be reprogrammed if desired and can retain the stored information even when not powered. Examples of reprogrammable non-volatile memory include Eeprom memory and flash memory.

Normally non-volatile memory is able to retain its programmed state for many years once programmed. However, commercially available non-volatile memory employs an imperfect charge storage mechanism which allows the charge, and therefore the stored data, to leak away over time.

Usually a non-volatile memory manufacturer will guarantee data retention for at least 10 years. For many electronics applications 10 years is an adequate guaranteed lifetime. However, many items of power transmission network equipment require a guaranteed operational lifetime of 40 years or more.

As a result it is currently necessary to instigate intrusive and potentially damaging maintenance procedures approximately every 10 years in relation to each item of network equipment. As well as adding to the cost of maintaining a power transmission network infrastructure, such maintenance procedures are highly inconvenient since they require at least a partial shutdown of the network equipment item which can interrupt power transmission.

There is a need, therefore, for improvements in relation to conventional non-volatile memory assemblies which obviate the need for the present periodical maintenance regimes.

### SUMMARY OF THE INVENTION

According to a first aspect of the invention there is provided a non-volatile memory assembly, for use in a programmable device within a power transmission network, comprising:

a non-volatile reprogrammable primary memory portion;

a secondary memory portion; and

a controller configured to:

direct a programmable device to access data from the secondary memory portion;

refresh the data in the primary memory portion with data from the secondary memory portion; and

direct the programmable device to access data from the primary memory portion.

The provision of a controller that is configured to refresh the data in the primary memory portion with data from the secondary memory portion allows the primary memory portion to provide data retention for a further guaranteed period, e.g. 10 years, from the date of refreshing.

Such extension of the guaranteed operational lifetime of the non-volatile memory is able to occur autonomously and so avoids the need for an associated intrusive maintenance procedure.

In the meantime, having a controller that is able to direct a programmable device to access data from the secondary memory portion, allows the aforementioned refreshing of the primary memory portion to take place while a programmable device in which the memory assembly is located continues to operate.

Accordingly the memory assembly of the invention allows, e.g. an item of power transmission network equipment, to continue operating while a refresh of the primary memory portion takes place.

Optionally the primary and secondary memory portions are discrete primary and secondary memory modules each of which is loadable with data as a whole.

Such an arrangement is readily configurable from commercially available memory modules while providing the aforementioned benefits of the invention.

In a preferred embodiment of the invention the primary memory module defines a plurality of primary data areas, the secondary module defines a plurality of secondary data areas, and the controller is configured selectively to direct the programmable device to access data from at least a first secondary data area and from at least a corresponding first primary data area.

The provision of respective primary and secondary data areas allows for the automatic direction of the programmable device from the data area of one memory module to an data area of the other memory module, e.g. in the event that a first data area is corrupted because of a power failure during the refresh of data therein.

In another preferred embodiment of the invention the primary memory portion is defined by a plurality of memory sectors in a primary memory module, each memory sector being loadable with data independently of the other memory sectors, and the secondary memory portion is defined by one of:

a redundant memory sector in the primary memory module; and

a secondary memory module having one or more memory sectors each of which is separately loadable with data.

The inclusion of a primary memory portion that is defined by a plurality of individually-loadable memory sectors, together with one or more further memory sectors in the secondary memory module reduces the overall amount of non-volatile memory required to implement the invention.

The secondary memory portion may be reprogrammable and the controller may be further configured to load data into the secondary memory portion. The ability to load data into the secondary memory portion helps to avoid the need to periodically check the integrity of the data held in the secondary memory portion.

Preferably the controller is configured to load data into the secondary memory portion after a predetermined time period. Such a controller therefore facilitates the automatic and unattended refresh of the primary memory portion within, e.g. the guaranteed retention lifetime of the primary memory portion.

In another preferred embodiment of the invention the controller is configured to load data from the primary memory portion into the secondary memory portion. Such an arrangement permits the refreshing of the primary memory portion, i.e. the extension of its guaranteed operational lifetime, without any external intervention, and so allows the invention to be deployed in remote and/or normally inaccessible locations.

A still further preferred embodiment of the invention includes a communication device connectable to a communication link, and a controller that is configured to load data received via the communication link into the secondary memory portion.

Such an arrangement provides the option of, e.g. updating and refreshing the data, i.e. execution code and configuration information, for a given item of power transmission network equipment from a central control location.

Optionally the controller is configured to check for errors in the primary memory portion and to direct the program running on the programmable device to access data in the secondary memory portion on detection of an error in the primary memory portion.

Such an arrangement allows, for example, each memory module to be initially loaded with identical configuration data and for the refresh step only to take place on detection of an error in the primary memory module.

This reduces the number of times the primary memory module is refreshed during its operational lifetime by only carrying out the refreshing step in the event that a corrupted primary memory module is identified. Such a reduction is desirable since most non-volatile reprogrammable memory has a finite (if very large) number of programming cycles, i.e. refresh cycles.

Such a feature also helps to ensure that the programmable device containing the memory assembly is able to continue functioning while the primary memory portion is refreshed, i.e. repaired.

Preferably the controller is configured to check for errors in the secondary memory portion and to refresh the secondary memory portion on detection of an error therein. Such a feature helps to maintain the integrity of any data held in the secondary memory portion. According to a second aspect of the invention there is provided a method of extending the operational lifetime of a programmable device for use in a power transmission network, comprising the steps of:

(a) providing the programmable device with a non-volatile reprogrammable primary memory portion and a secondary memory portion;

(b) directing a programmable device to access data from the secondary memory portion;

(c) refreshing the data in the primary memory portion with the data from the secondary memory portion; and

(d) directing the programmable device to access data from the primary memory portion.

The method of the invention shares the benefits of the corresponding features of the memory assembly of the invention.

Optionally providing the programmable device with primary and secondary memory portions includes providing the programmable device with discrete primary and secondary memory modules each of which is loadable with data as a whole.

Preferably providing the programmable device with discrete primary and secondary memory modules includes providing a primary memory module that defines a plurality of primary data areas and a secondary memory module that defines a plurality of secondary data areas, and wherein the method further includes the step of selectively directing the programmable device to access data from at least a first secondary data area and from at least a corresponding first primary data area.

In a preferred embodiment of the invention providing a non-volatile primary memory portion includes providing a primary memory module having a plurality of memory sectors each of which is loadable with data independently of the other memory sectors, and wherein providing a secondary memory portion includes providing a secondary memory portion defined by one of:

a redundant memory sector in the primary memory module; and

a secondary memory module having one or more memory sectors each of which is separately loadable with data.

Another preferred embodiment of the invention further includes providing a reprogrammable secondary memory portion, and the step of loading data into the secondary memory portion.

Loading data into the secondary memory portion may include loading data into the secondary memory portion after a predetermined time period.

Optionally loading data into the secondary memory portion includes loading data from the primary memory portion into the secondary memory portion.

The method of the invention may also include the step of providing a communication device connectable to a communication link, and wherein loading data into the secondary memory portion includes loading data received via the communication link into the secondary memory portion.

A further preferred embodiment of the invention includes the steps of:

checking for errors in the primary memory portion; and

directing the programmable device to access data in the secondary memory portion on detection of an error in the primary memory portion.

Preferably the method of extending the operational lifetime of a programmable device further includes the steps of:

checking for errors in the secondary memory portion; and

refreshing the secondary memory portion on detection of an error therein.

### BRIEF DESCRIPTION OF THE DRAWINGS

There now follows a brief description of preferred embodiments of the invention, by way of non-limiting examples, with reference being made to the accompanying drawings in which:

FIG. 1 shows a schematic view of a non-volatile memory assembly according to a first embodiment of the invention;

FIG. 2 shows a schematic view of a non-volatile memory assembly according to a second embodiment of the invention;

FIG. 3 shows a schematic view of a non-volatile memory assembly according to a third embodiment of the invention;

FIG. 4 shows a schematic view of a non-volatile memory assembly according to a fourth embodiment of the invention;

FIG. 5(a) shows a schematic view of a non-volatile memory assembly according to a fifth embodiment of the invention including a first secondary memory portion; and

FIG. 5(b) shows a schematic view of the non-volatile memory assembly according to the fifth embodiment of the invention including a second secondary memory portion.

### DESCRIPTION OF THE PREFERRED EMBODIMENTS

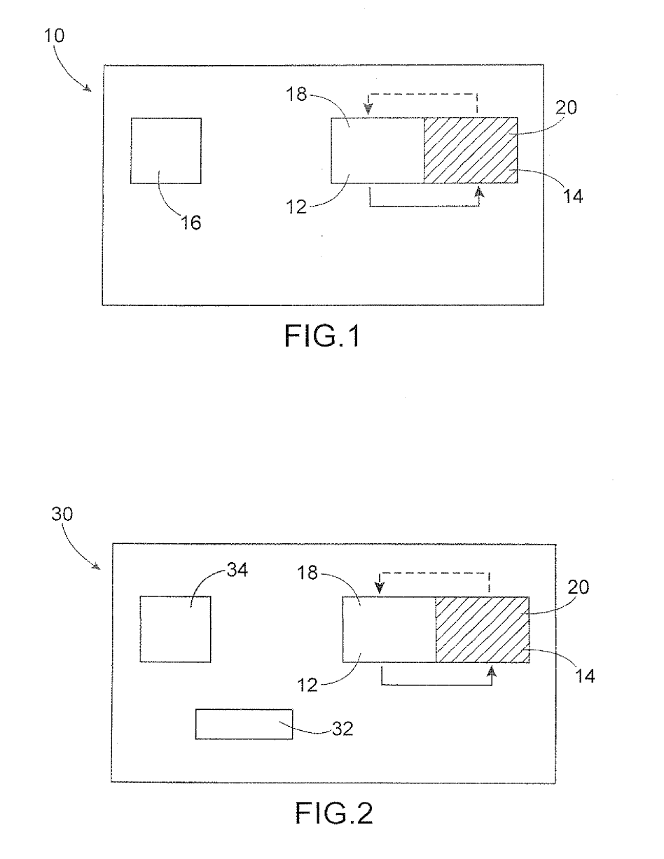

A non-volatile memory assembly according to a first embodiment of the invention shown is FIG. 1 is designated generally by the reference numeral 10.

The memory assembly 10 includes a non-volatile reprogrammable primary memory portion 12 and a reprogrammable secondary memory portion 14, together with a controller 16. The secondary memory portion 14 shown is non-volatile, although in other embodiments of the invention it may be volatile, i.e. it may loose its contents in the absence of a power source.

In this and the other embodiments of the invention described herein the primary memory portion 12 is the memory portion from which an associated programmable device is initially retrieving data, while the secondary memory portion 14 is a memory portion which is initially unused by the associated programmable device. This need not, however, always be the case in other embodiments of the invention.

In addition, in the context of this invention data includes execution code for an associated programmable device and configuration information for an equipment item that is controlled by the programmable device.

The primary memory portion 12 is a discrete non-volatile primary memory module 18 and the secondary memory portion 14 is a discrete non-volatile secondary memory module 20. Each of the primary and secondary memory modules 18, 20 is loadable with data as a whole.

The controller 16 may be separate from each of the memory modules 18, 20 or may be otherwise embodied in the programmable device in which the memory modules 18, 20 are incorporated.

The controller 16 is configured to direct an associated programmable device to access data from the secondary memory portion; refresh the data in the primary memory portion with data from the secondary memory portion; and direct the programmable device to access data from the primary memory portion.

The controller 16 shown in FIG. 1 is also configured to load data into the secondary memory portion 14, i.e. the secondary memory module 20, after a predetermined time period.

In the embodiment shown the predetermined time period is 10 years from installation and initiation of the programmable device in which the memory assembly 10 is located. In other embodiments of the invention (not shown) the predetermined time period is less than 10 years after installation and initiation of the programmable device. In any event the predetermined time period is preferably more than 5 years after installation and initiation.

The controller 16 is configured to load data from the primary memory portion 12 into the secondary memory portion 14, i.e. to copy the content of the primary memory module 18 into the secondary memory module 20.

In use the primary memory portion 12 contains execution code to control the operation of the programmable device in which it is located, and configuration information for an equipment item to allow the programmable device to control the operation of the equipment item in which the programmable device is itself located.

On expiration of the predetermined time period, i.e. 10 years after installation and initiation of the programmable device, the controller 16 copies the contents of the primary memory module 18 into the secondary memory module 20. The controller 16 may, optionally, erase the secondary memory module 20 before copying the primary memory module 18 data into it.

After loading the aforementioned data into the secondary memory module 20 the contents of the secondary memory module 20 may, if desired, be verified.

The controller 16 then directs the programmable device to access data from the secondary memory portion 14, i.e. the secondary memory module 20.

Since the content of the secondary memory module 20 is identical to the content of the primary memory module 18 the programmable device continues to operate as before and so functioning of the associated equipment item is uninterrupted.

The data in the primary memory module 18 is then refreshed by the controller 16 with the data from the secondary memory module 20. Refreshing the data in the primary memory module 18 effectively means reprogramming the primary memory module 18 with the original execution code and configuration information. The controller 16 may, optionally, precede the refreshing procedure by erasing the primary memory module 18.

Refreshing the data in the primary memory module 18 in the aforementioned manner restarts the guaranteed retention period for the module 18, and so in practice extends the guaranteed operational lifetime of the primary memory module 18 by a further guaranteed period, e.g. 10 years.

The controller 16 then directs the programmable device to revert to accessing data from the (now refreshed) primary memory module 18. The content of the primary memory module 18 is identical to its previous configuration and so the program and associated equipment item continue to operate without interruption.

The controller 16 is configured to direct the programmable device to access data from each of the primary and secondary memory modules 18, 20, as required, by altering the status of a non-volatile switch in the significant address line of the programmable device. In this way the change from accessing data from one of the primary or secondary memory module 18, 20 to the other of the primary or secondary memory module 18, 20 takes place in a single clock cycle of the programmable device, and so helps to ensure that operation of the equipment item is not disrupted.

The status of the non-volatile switch in the significant address line can also be used to indicate to the controller 16 whether a refresh of the data in the primary memory module 18 is required.

A non-volatile memory assembly 30 according to a second embodiment of the invention is illustrated in FIG. 2.

The second memory assembly 30 is similar to the first memory assembly 10 but differs in that it includes a second controller 34 that is configured to operate in a different manner to the first controller 16 of the first memory assembly 10, and in that it additionally includes a communication device 32.

The communication device 32 is connectable to a communication link (not shown), and the second controller 34 is configured to load data received via the communication link into the secondary memory portion 14, i.e. the secondary memory module 20.

In use the primary memory portion 12 again contains execution code to control the operation of the programmable device in which it is located, and configuration information for an associated equipment item in which the programmable device is itself located.

On expiration of a predetermined time period, i.e. 10 years after installation and initiation of the programmable device, or on an instruction received via the communication link, the second controller 34 loads the secondary memory module 20 with data received via the communication link. The second controller 34 may, optionally, erase the secondary memory module 20 before loading the data into it.

The data loaded into the secondary memory module 20 will be similar to the data that is initially contained in the primary memory module 18, but may include desirable firmware updates or the like.

After loading the aforementioned data into the secondary memory module 20 the contents of the secondary memory module 20 may, if desired, be verified.

The second controller 34 then operates in a similar manner to the first controller 16, i.e. it directs the programmable device to access data from the secondary memory module 20. The second controller 34 directs the programmable device to access data from the secondary memory module 20 at a desirable moment in time such as, for example, as the programmable device completes its program loop and is about to execute the program loop again.

The programmable device continues to operate essentially as before and so functioning of the associated equipment item is uninterrupted.

The second controller 34 then refreshes the data in the primary memory module 18 with the new data from the secondary memory module 20. The second controller 34 may again, optionally, precede the refreshing procedure by erasing the primary memory module 18.

Refreshing the data in the primary memory module 18, as above, extends the guaranteed operational lifetime of the primary memory module 18 by a further guaranteed period, e.g. 10 years.

The second controller 34 then directs the programmable device to revert to accessing data from the (now refreshed and updated) primary memory module 18. The programmable device and associated equipment item continue to operate without interruption.

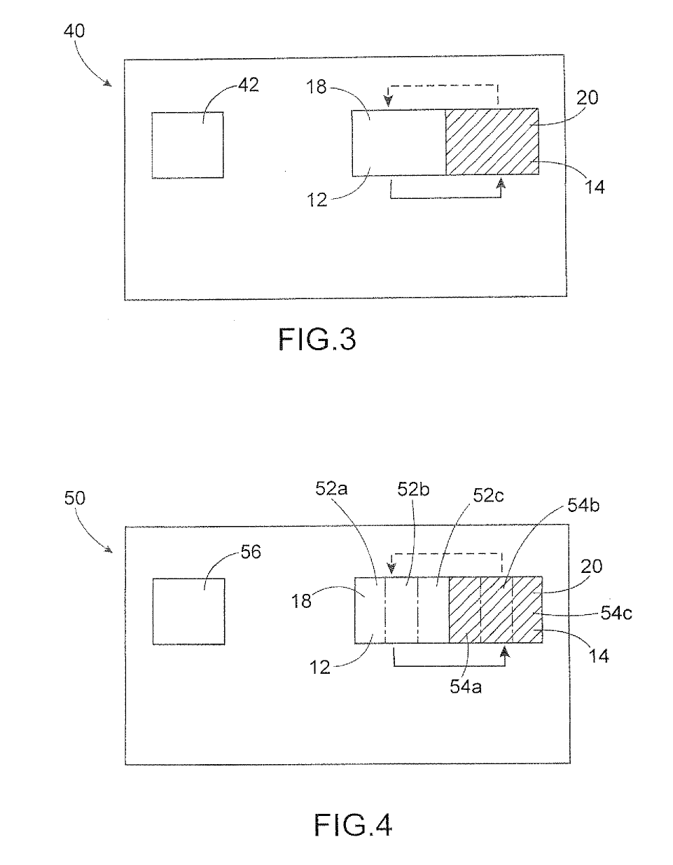

A non-volatile memory assembly 40 according to a third embodiment of the invention has essentially the same structure as the first memory assembly 10, as illustrated in FIG. 3.

However, the third memory assembly 40 differs in that it includes a third controller 42 that is configured to operate in a different manner to the first controller 16.

In particular, the third controller 42 is configured to check for errors in each of the memory portions 12, 14, i.e. memory modules 18, 20, and to carry out certain operations on detection of an error in one of the memory modules 18, 20.

More specifically, the third controller 42 is configured on detection of an error in the primary memory portion 12 (i.e. the memory portion from which an associated programmable device is retrieving data) to direct a program running on the programmable device to access data from the un-corrupted secondary memory module; then refresh the data in the corrupted primary memory module 18 with data from the uncorrupted secondary memory module 20; and finally direct the programmable device to access data from the (now refreshed and corrected) primary memory module 18.

The third controller 42 is also configured to refresh the secondary memory portion 14 (i.e. the memory portion from which no data is being retrieved) on detection of an error in the secondary memory portion 14. The third controller 42 performs the refresh by reprogramming the secondary memory portion 14 with uncorrupted data.

In use each of the memory portions 12, 14, i.e. memory modules 18, 20, contains the same data to control the operation of the programmable device and associated equipment item in which they are located.

The third controller 42 periodically checks for errors in each of the memory modules 18, 20. The third controller 42 is configured to check for an error in each memory module 18, 20 as a whole, e.g. using a checksum routine.

On detection of an error in the primary memory module 18 the third controller 42 directs the programmable device to access data from the un-corrupted secondary memory module 20.

The third controller 42 then refreshes the data in the corrupted primary memory module 18 with data from the uncorrupted secondary memory module 20, and directs the programmable device to access data from the primary memory module 18.

In further use, on detection of an error in the secondary memory module 20 the third controller 42 refreshes the secondary memory module 20, e.g. with data from the primary memory module 18.

Accordingly the guaranteed retention period for a previously corrupted, primary or secondary memory module 18, 20 is reset, and so the guaranteed operational lifetime of the previously corrupted memory module 18, 20 is extended by a further guaranteed period, e.g. 10 years.

A non-volatile memory assembly according to a fourth embodiment of the invention is designated generally by the reference numeral 50.

The fourth memory assembly 50 has a similar structure to the first memory assembly 10, as illustrated in FIG. 4.

The fourth memory assembly 50 differs, however, from the first memory assembly 10 in that the primary memory module 18 defines a plurality of primary data areas 52. In the embodiment shown the primary memory module 18 includes first, second and third primary data areas 52a, 52b, 52c. Other embodiments of the invention may include fewer than or more than three primary data areas.

The fourth memory assembly 50 is also different because the secondary memory module 20 defines first, second and third secondary data areas 54a, 54b, 54c. Other embodiments of the invention may again include a different number of secondary data areas.

The fourth memory assembly 50 includes a fourth controller 56 which is configured selectively to direct a programmable device (in which the fourth memory assembly 50 is located) to access data from at least a first secondary data area 54a, 54b, 54c and from at least a corresponding first primary data area 52a, 52b, 52c.

In use the primary memory portion 12, i.e. the primary memory module 18, contains the data to control the operation of the programmable device in which it is located and an associated equipment item.

The fourth controller 56 operates in a similar manner to each of the first and second controllers 16, 34 to refresh the data in the primary memory module 18.

Similarly the fourth controller 56 then directs the programmable device to access data from the refreshed primary memory module 18.

Following such direction the programmable device will attempt to load data from the first primary data area 52a.

If the first primary data area 52a is erased or only partially loaded with data, e.g. because power was lost during the aforementioned refresh operation, then the programmable device will load data from the first secondary data area 54a. The integrity of the data in the first primary data area 52a may be checked by the fourth controller 56, e.g. using a checksum routine, so as to allow the fourth controller 56 to direct the program to access data from the corresponding first secondary data area 54a.

The fourth controller 56 then refreshes the data in at least the first primary data area 52a for a second time before directing the program to access data from the corresponding primary data area, i.e. the first primary data area 52a.

In this way the fourth memory assembly 50 provides a degree of protection for memory corruption that may occur as a result of, e.g. a power failure during a refresh operation.

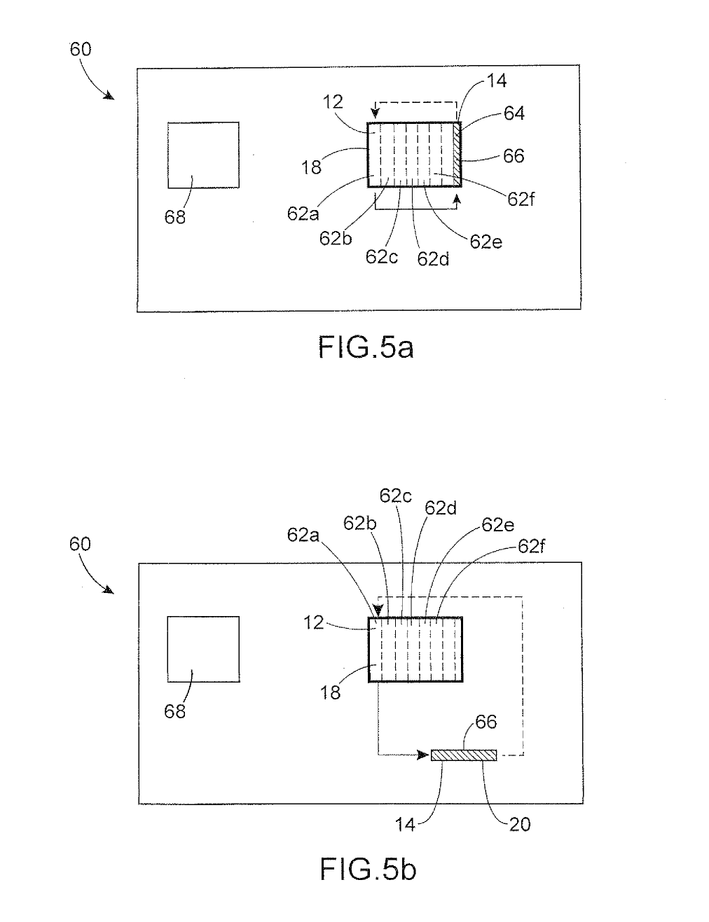

A memory assembly 60 according to a fifth embodiment of the invention is shown schematically in FIG. 5(a).

The fifth memory assembly 60 includes a primary memory portion 12 that is defined by a plurality of primary memory sectors 62 in a primary memory module 18. Each primary memory sector 62 is loadable with data independently of the other primary memory sectors 62.

In particular, the primary memory portion 12 includes first, second, third, fourth, fifth and sixth primary memory sectors 62a, 62b, 62c, 62d, 62e, 62f. In other embodiments of the invention (not shown) the primary memory portion may include a different number of primary memory sectors 62, and preferably a much larger number of primary memory sectors 62.

The fifth memory assembly 60 also includes a secondary memory portion 14 that is defined by a redundant memory sector 64 in the primary memory module 18, i.e. a secondary memory sector 66.

The first memory assembly 60 may, alternatively, include a secondary memory portion 14 that is defined by a secondary memory module 20 that includes at least one secondary memory sector 66, the or each of which is separately loadable with data, as illustrated schematically in FIG. 5(b).

In addition the fifth memory assembly 60 includes a fifth controller 68 that is similar to each of the aforementioned controllers 16; 34; 42; 56 but which is configured to operate in a different manner.

In use the primary memory sectors 62 of the primary memory portion 12 contain the execution code and configuration information to control the operation of the programmable device in which the primary memory portion 12 is located and the associated equipment item.

On expiration of a predetermined time period, i.e. 10 years after installation and initiation, the fifth controller 68 copies the contents of the first primary memory sector 62a to the secondary memory sector 66. The fifth controller 68 may, if desired, verify the data copied to the secondary memory sector 66.

In an alternative embodiment (not shown) the fifth controller 68 may, either on expiration of the predetermined period or on receipt of instructions via a communication link, load data received via the communication link into the secondary memory sector 66.

In each case the fifth controller 68 then directs the programmable device to access data from the secondary memory sector 66 instead of the first primary memory sector 62a.

The fifth controller 68 then refreshes the data in the first primary memory sector 62a and directs the programmable device to again access data from the primary memory sector 62a.

The controller repeats the forgoing steps so as to refresh each of the remaining primary memory sectors 62b, 62c, 62d, 62e, 62f.

In a still further embodiment (not shown) the fifth controller 68 may be configured to check and correct for an error within each single memory bit of each of the primary memory sectors 62a, 62b, 62c, 62d, 62e, 62f.

On detection of a bit error in a given primary memory sector 62 the fifth controller 68 copies the content of the corrupted primary memory sector 62 via an error correction algorithm to the secondary memory sector 66, and then directs the programmable device to access data from the secondary memory sector 66 so as to allow the programmable device, and associated equipment item, to continue operating.

In the meantime the fifth controller 68 copies the corrected data in the secondary memory sector 66 to the primary memory sector 62, thus repairing the corruption. The fifth controller 68 then directs the programmable device to access data from the (now-corrected) primary memory sector 62 so as to allow the programmable device, and associated equipment item, to continue operating.

1. A non-volatile memory assembly, for use in a programmable device within a power transmission network, comprising:
a non-volatile reprogrammable primary memory portion;
a secondary memory portion; and
a controller configured to:
direct a programmable device to access data from the secondary memory portion;
refresh the data in the primary memory portion with data from the secondary memory portion; and
direct the programmable device to access data from the primary memory portion wherein the primary memory portion is defined by a plurality of memory sectors in a primary memory module, each memory sector being loadable with data independently of the other memory sectors, and the secondary memory portion is defined by one of:
a redundant memory sector in the primary memory module; and
a secondary memory module having one or more memory sectors, each of which is separately loadable with data.

2. A non-volatile memory assembly according to claim 1 wherein the primary and secondary memory portions are discrete primary and secondary memory modules each of which is loadable with data as a whole.

3. A non-volatile memory assembly according to claim 2 wherein the primary memory module defines a plurality of primary data areas, the secondary module defines a plurality of secondary data areas, and the controller is configured selectively to direct the programmable device to access data from at least a first secondary data area and from at least a corresponding first primary data area.

4. (canceled)

5. A non-volatile memory assembly according to claim 3 wherein the secondary memory portion is reprogrammable and the controller is further configured to load data into the secondary memory portion.

6. A non-volatile memory assembly according to claim 5 wherein the controller is configured to load data into the secondary memory portion after a predetermined time period.

7. A non-volatile memory assembly according to claim 5 wherein the controller is configured to load data from the primary memory portion into the secondary memory portion.

8. A non-volatile memory assembly according to claim 5 further including a communication device connectable to a communication link, and wherein the controller is configured to load data received via the communication link into the secondary memory portion.

9. A non-volatile memory assembly according to claim 1 wherein the controller is configured to check for errors in the primary memory portion and to direct the program running on the programmable device to access data in secondary memory portion on detection of an error in the primary memory portion.

10. A non-volatile memory assembly according to claim 1 wherein the controller is configured to check for errors in the secondary memory portion and to refresh the secondary memory portion on detection of an error therein.

11. A method of extending the operational lifetime of a programmable device for use in a power transmission network, comprising the steps of:
(a) providing the programmable device with a non-volatile reprogrammable primary memory portion and a secondary memory portion;
(b) directing the programmable device to access data from the secondary memory portion;
(c) refreshing the data in the primary memory portion with the data from the secondary memory portion; and
(d) directing the programmable device to access data from the primary memory portion, wherein a non-volatile primary memory portion includes providing a primary memory module having a plurality of memory sectors each of which is loadable with data independently of the other memory sectors, and in that providing a secondary memory portion includes providing a secondary memory portion defined by one of;
a redundant memory sector in the primary memory module; and
a secondary memory module having one or more memory sectors each of which is separately loadable with data.

12. A method of extending the operational lifetime of a programmable device according to claim 11 wherein providing the programmable device with primary and secondary memory portions includes providing the programmable device with discrete primary and secondary memory modules each of which is loadable with data as a whole.

13. A method of extending the operational lifetime of a programmable device according to claim 12, wherein providing the programmable device with discrete non-volatile primary and secondary memory modules includes providing a primary memory module that defines a plurality of primary data areas and a secondary memory module that defines a plurality of secondary data areas, and wherein the method further includes the step of selectively directing the programmable device to access data from at least a first secondary data area and from at least a corresponding first primary data area.

14. (canceled)

15. A method of extending the operational lifetime of a programmable device according to claim 12 wherein providing a secondary memory portion includes providing a reprogrammable secondary memory portion, and the method further includes the step of loading data into the secondary memory portion.

16. A method of extending the operational lifetime of a programmable device according to claim 15, wherein loading data into the secondary memory portion includes loading data into the secondary memory portion after a predetermined time period.

17. A method of extending the operational lifetime of a programmable device according to claim 15, wherein loading data into the secondary memory portion includes loading data from the primary memory portion into the secondary memory portion.

18. A method of extending the operational lifetime of a programmable device according to claim 15 further including the step of providing a communication device connectable to a communication link, and wherein loading data into the secondary memory portion includes loading data received via the communication link into the secondary memory portion.

19. A method of extending the operational lifetime of a programmable device according to claim 11 further including the steps of:
checking for errors in the primary memory portion; and
directing the programmable device to access data in the secondary memory portion on detection of an error in the primary memory portion.

20. A method of extending the operational lifetime of a programmable device according to claim 11 further including the steps of:
checking for errors in the secondary memory portion; and
refreshing the secondary memory portion on detection of an error therein.
